(19) United States
(12) Patent Application Publication
(10) Pub. No.: US 2007/0171077 A1
(43) Pub. Date: Jul. 26, 2007

(54) License Plate Incorporating RFID Device

(76) Inventor: Behrouz Kawarizadeh, New Albany, OH (US)

Correspondence Address: ELEY LAW FIRM CO., 7870 OLENTANGY RIVER RD, SUITE 311, COLUMBUS, OH, 43235, US

(21) Appl. No.: 11/627,090

(22) Filed: Jan. 25, 2007

Related U.S. Application Data
(60) Provisional application No. 60/762,552, filed on Jan. 26, 2006.

(51) Int. Cl. G08B 13/14

(52) U.S. Cl. 340/572.8

(57) ABSTRACT

A license plate for a vehicle. The license plate includes a generally planar base having a front surface and a rear surface. A cavity is disposed in at least one of the front surface and the rear surface. An RFID tag is situated in the cavity. A closure is coupled to the license plate to close off the cavity.

This application claims priority to U.S. provisional application 60/762,552, filed Jan. 26, 2006, the contents of which are hereby incorporated by reference.

### FIELD

This invention relates to a component of a system for registering, identifying and tracking the location of motor vehicles. Specifically, the invention relates to a license plate for identifying a vehicle for registering, tracking and monitoring of the vehicle within a political subdivision or jurisdiction or among cooperating jurisdictions.

### BACKGROUND

Urban growth has resulted in a substantial increase in the number of registered vehicles. Each vehicle is typically required by a political subdivision, such as a state, to undergo an annual safety inspection and license re-registration. A goal of this process is to keep unsafe vehicles off the roads and to maintain current ownership information for the vehicles. There is a desire to make the process for registering and re-registering vehicles as efficient as possible, in order to minimize inconvenience to vehicle owners and maximize the revenue that political subdivisions derive for providing such services. Currently, major metropolitan cities face daunting challenges in registering and re-registering vehicles because the only current means to determine whether a vehicle registration has expired is to visually inspect the vehicle's license plates, or check the vehicle license plate number and/or Vehicle Identification Number (“VIN”) against a database maintained by a law enforcement entity.

The process of ticketing parking violators is equally daunting, given the number of parking spaces in a typical major metropolitan city. A parking meter associated with each parking space must be visually checked by law enforcement personnel to determine if the time allotted by the meter has expired. If the meter has expired, law enforcement personnel must make a visual inspection of the vehicle to obtain the license number and/or VIN and write out a parking citation. Furthermore, the collection of coins from parking meters is cumbersome. Attendants are tasked with collecting the deposited coins in each parking meter and then transporting them to a central location to be counted. This method of collecting parking fees is inefficient.

In addition, there is a constant need to monitor traffic pattern movements and the speed of vehicles, particularly in high-risk areas such as construction zones, school zones and residential areas. This is difficult and time-consuming, as each of these scenarios presently require the presence of a law enforcement officer.

Because of the labor-intensive nature of enforcing existing vehicle registration and traffic laws and the magnitude of the effort, a large number of re-registration fees and potential fines for traffic citations and go uncollected each year, contributing to decreased traffic safety and a corresponding loss of revenue to the responsible jurisdiction. Similarly, current enforcement systems and methods are prone to human error and misidentification. For example, it is not uncommon for law enforcement personnel to transpose or leave out digits in a license plate or VIN number while writing a citation, making subsequent tracking of the status of the citation and enforcement of the citation difficult and labor-intensive.

A long-recognized problem with current vehicle registration systems is that a vehicle owner is often required to wait in line for lengthy periods of time at a registrar's office for a re-issuance of a paper document evidencing re-registration of the vehicle. Consequently, some vehicles go unregistered and continue to be driven at the expense of safety and the public coffers. Further, when new vehicle license plates are issued, there is no way for the registrar to ensure that the registrant installs the new license plates on the vehicle for which they were issued. License plates may also be lost or stolen and affixed to vehicles to which they are not registered, perhaps in an effort to cloak criminal activity.

As workforce labor and other overhead expenses rise, there is an increasing need to improve the collection efficiency of fines associated with traffic and registration violations and minimize the number of employees needed to accomplish this task. Government offices are continually under budget constraints and are constantly seeking to streamline their operation to cut costs and increase revenue. One such activity is taking regular inventory of the registered vehicles within a given jurisdiction. Regular inventorying is needed for budgetary purposes and to facilitate ordering of replacement tags or re-registering an existing vehicle.

Another concern involves a type of theft called “pilfering” in which an employee working within the vehicle registration system steals license plates and provides them to criminal elements. Pilfering is particularly troublesome since dishonest employees are usually aware of security precautions that are in place and how to avoid detection. An even more serious form of theft involves stolen vehicles, where many such vehicles are quickly disassembled and resold as parts. Consequently, locating a stolen vehicle within a short timeframe is often crucial to its recovery.

Novel systems and methods utilizing Radio Frequency Identification (RFID) tags have been devised to overcome the aforementioned problems. However, there is a need to affix the RFID tags to the vehicles in a non-conspicuous manner that resists tampering, yet does not hamper RFID scanners from remotely interrogating the affixed tag.

### SUMMARY

In one embodiment of the present invention a license plate for a vehicle incorporates an RFID tag. The license plate comprises a base having a front surface and a rear surface. Visually perceivable information is disposed upon the front surface, the information relating to at least one of the political subdivision and a vehicle to which the license plate is registered. A cavity is formed in the license plate and an RFID tag is placed into the cavity. A sealant generally encapsulates the RFID tag. The RFID tag is responsive to radio frequency signals from a remote source, as the license plate does not significantly attenuate the radio frequency signals.

An object of the present invention is an embodiment of a vehicle license plate incorporating an RFID tag. The license plate includes a generally planar base having a front surface and a rear surface. A cavity is formed in at least one of the front surface and the rear surface. An RFID tag is situated in the cavity. A closure coupled to the license plate closes off the cavity.

Another object of the present invention is another embodiment of a vehicle license plate incorporating an RFID tag. The license plate includes a generally planar base having a front surface and a rear surface, and a generally planar cover having a front surface and a rear surface. A cavity is formed in at least one of the front surface of the base and the rear surface of the cover. An RFID tag is situated in the cavity. The license plate is formed by joining the rear surface of the cover to the front surface of the base, thereby encapsulating the RFID tag.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1A is a front elevational view of a license plate according to an embodiment of the present invention;

FIG. 1B is a rear elevational view of the license plate of FIG. 1A;

FIG. 1C is a view in section of the license plate of FIG. 1A;

FIG. 2A is a front elevational view of a license plate according to another embodiment of the present invention;

FIG. 2B is a view in section of the license plate of FIG. 2A;

FIG. 3A is a front elevational view of a base of a license plate according to an alternate embodiment of the present invention;

FIG. 3B is a view in section of the base of FIG. 3A;

FIG. 3C is a front elevational view of a cover of a license plate according to an alternate embodiment of the present invention;

FIG. 3D is a view in section of the cover of FIG. 3C;

FIG. 3E depicts an assembled license plate according to an alternate embodiment of the present invention;

FIG. 3F is a view in section of the license plate of FIG. 3E;

FIG. 4 is a front elevational view of a license plate according to another alternate embodiment of the present invention; and

FIG. 5 is a rear elevational view of a license plate according to yet another alternate embodiment of the present invention.

### DETAILED DESCRIPTION

In the discussion that follows, like reference numerals are used to refer to like structures and elements.

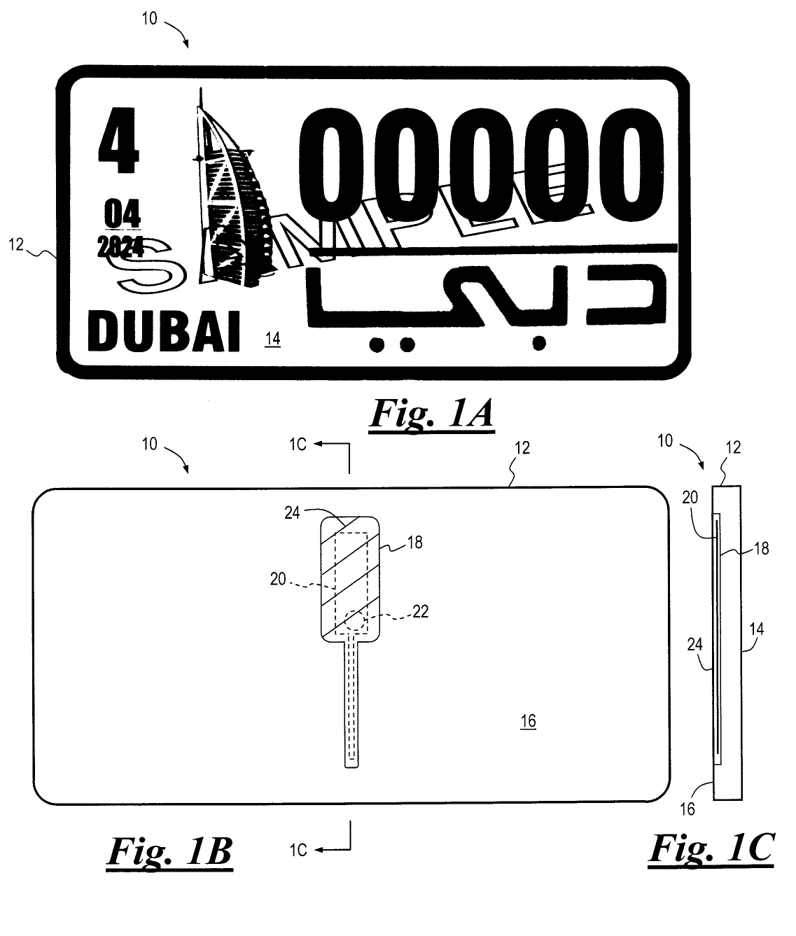

A license plate 10, shown in FIGS. 1A, 1B and 1C, comprises a generally planar base 12 having a front surface 14, a rear surface 16 and a cavity 18.

Base 12 may be made from any unitary piece of material suitable for the forces and environmental conditions expected for license plate 10. The material selected for base 12 is preferably nonconductive or is provided with apertures configured to reduce the attenuation of radio frequency signals by the base. Base 12 is also preferably resistant to degradation from ultraviolet radiation. Example materials include, without limitation, metal, composites and plastics such as ABS and LEXAN®. In addition, base 12 and its associated features may be formed in any conventional manner including, but not limited to, casting, machining, forming, molding, stamping and spinning. Furthermore, base 12 and its associated components and features may be finished in any conventional manner, such as painting, dipping, coating or plating, or may be left unfinished.

Front surface 14 is generally planar and is configured to display visually perceivable information relating to the political subdivision and/or the vehicle to which license plate 10 is registered. Example information includes, without limitation, a registration number, the name of the political subdivision, registration expiration data, graphical symbols relating to the political subdivision, and so on. The visual information is imprinted in any conventional manner, including molding, machining, printing, embossing, screening, etching and engraving, and may be provided with a clear protective coating or layer.

Rear surface 16 is generally planar and may include cavity 18 disposed therein. Alternatively, in some embodiments of the present invention cavity 18 may be disposed in front surface 14 in the same manner as shown for rear surface 16 in FIGS. 1B, 1C. Cavity 18, which is shaped to receive a conventional RFID tag 20, may be formed in any conventional manner, such as molding and machining. The depth of cavity 18 may vary but is typically sufficient to situate RFID tag 20 therein and substantially encapsulate the RFID tag with a sealant (discussed below), the sealant being generally coplanar with the surface of rear surface 16 when the cavity is filled therewith.

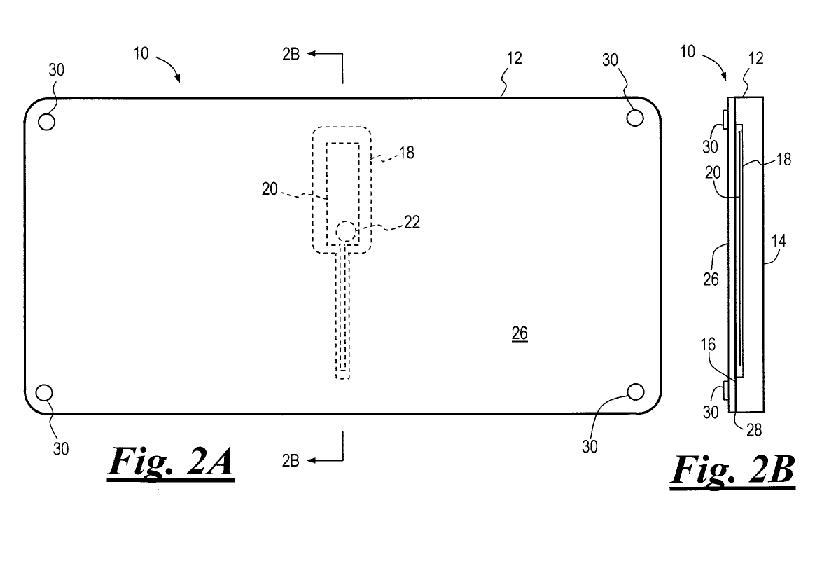

License plate 10 is assembled by placing a conventional passive-type or active-type RFID tag 20 into cavity 18. In the case of an active-type RFID tag 20 the tag may also comprise a power supply 22 such as a long-life and/or rechargeable battery to power the tag. Cavity 18 is then closed off with a closure. In one embodiment of the present invention the cavity is filled with a sealing material 24 (FIG. 1B) such as, for example, adhesive, hot-melt and epoxies, the sealing material generally encapsulating and sealing RFID tag 20 from the elements and preventing subsequent tampering or removal of the RFID tag from base 12. Alternatively, a generally planar recessed cover 26 may be used to close off cavity 18 as shown in FIGS. 2A and 2B, the cover being joined to base 12 and secured thereto with adhesive or ultrasonic welds 28, or fasteners such as tamper-resistant screws 30. In some embodiments of the present invention the visual information on front surface 14 may instead be placed on cover 26.

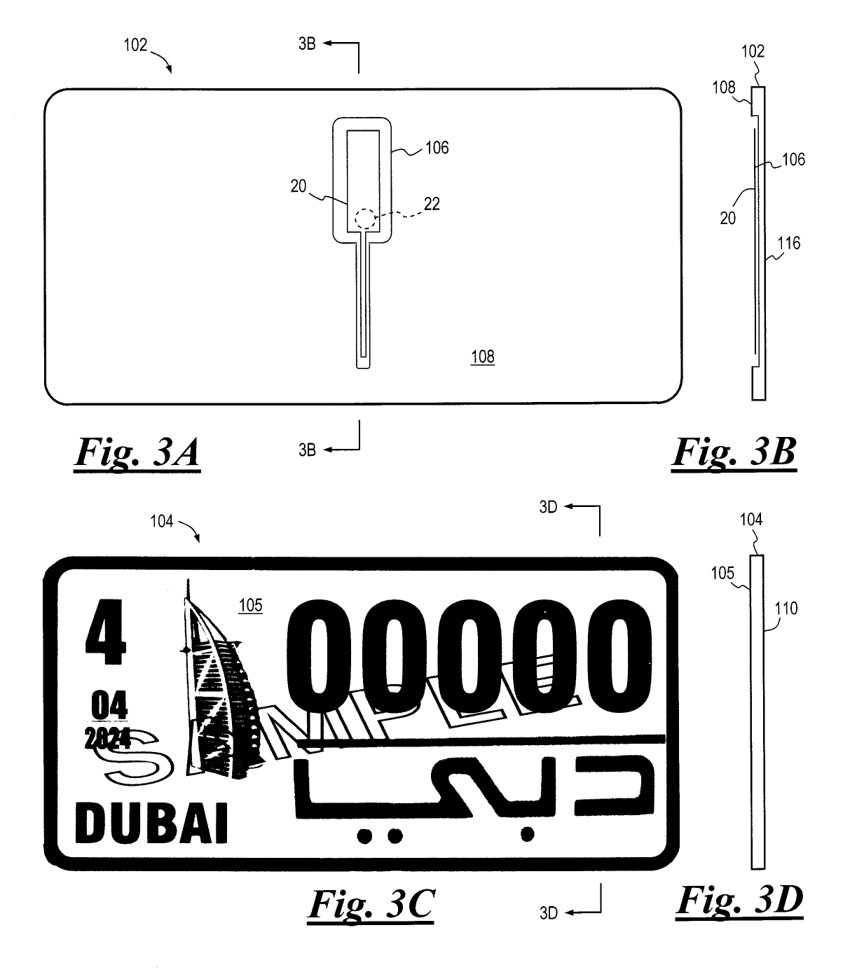

A license plate 100 according to an alternate embodiment of the present invention is shown in FIGS. 3A through 3F. License plate 100 comprises a base 102 and a cover 104. Base 102 may be constructed using the same materials, fabrication processes and finishes as base 12 and thus will not be reiterated here. A cavity 106 is formed in a front surface 108 of base 102 in any conventional manner, such as discussed above for cavity 18. Cover 104 is likewise constructed using the same materials, fabrication processes and finishes as base 12, and may be imprinted with visual information on a front surface 105 in the same manner as front surface 14 of base 12, discussed above.

License plate 100 is assembled by placing an RFID tag 20 into cavity 106 of base 102. RFID tag 20 may optionally be secured in any conventional manner, such as adhesive, sealants and tape to hold it in place during assembly. Cover 104 is placed atop and aligned with base 102, with a rear surface 110 of the cover facing front surface 108 of the base. Cover 104 is then joined to the base 102 in any conventional manner, such as adhesive or ultrasonic welds 112, molding, and fasteners such as tamper-resistant screws 114. The assembled license plate 100 appears as generally shown in FIGS. 3E and 3F.

Although cavity 106 is formed into front surface 108 of base 102 in the foregoing discussion, it is understood that in some embodiments the cavity may alternatively be formed in rear surface 110 of cover 104 in the same manner as depicted for the base in FIGS. 3A, 3B. Likewise, cavity 106 may be disposed in generally aligned, facially adjacent areas of both front surface 108 and rear surface 110. Furthermore, in some embodiments of the present invention the visual information on front surface 105 may instead be placed on a rear surface 116 of base 102.

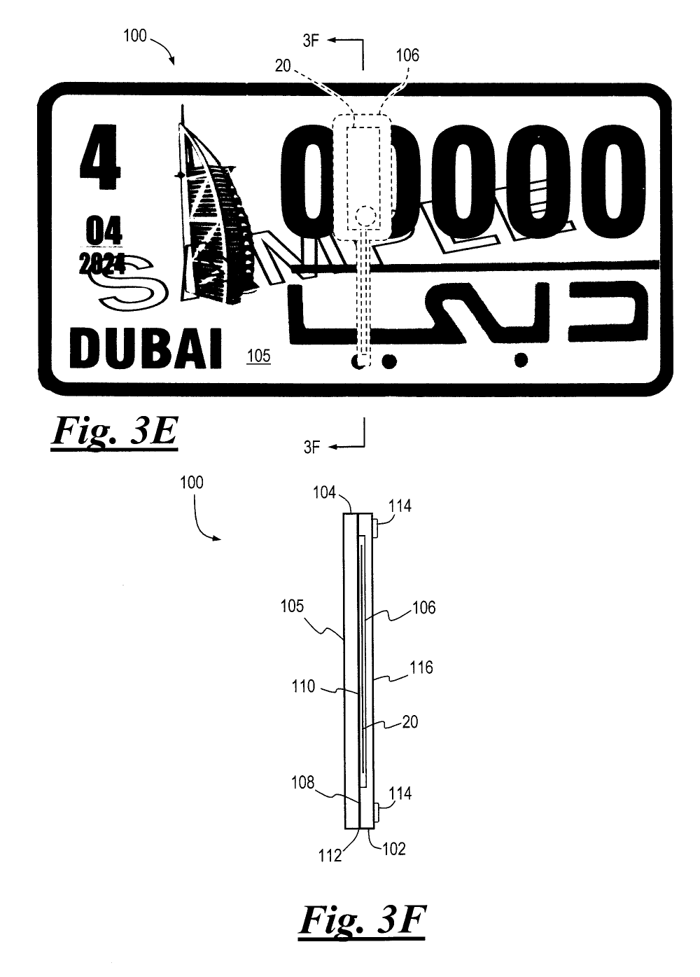

With reference to FIG. 4, in another alternate embodiment of the present invention one or more solar cells 202 may be installed in a license plate 200. Solar cells 202 are proximate a front surface 204 and are arranged to be exposed to solar radiation when license plate 200 is affixed to a vehicle. Solar cells 202 are electrically connected to a power supply 22 of an RFID tag 20 (see, e.g., FIGS. 1B and 3A). Solar cells 202 generate electricity when exposed to solar radiation, the electricity effective to operate RFID tag 20 and/or re-charge power supply 22, such as a battery, of the RFID tag.

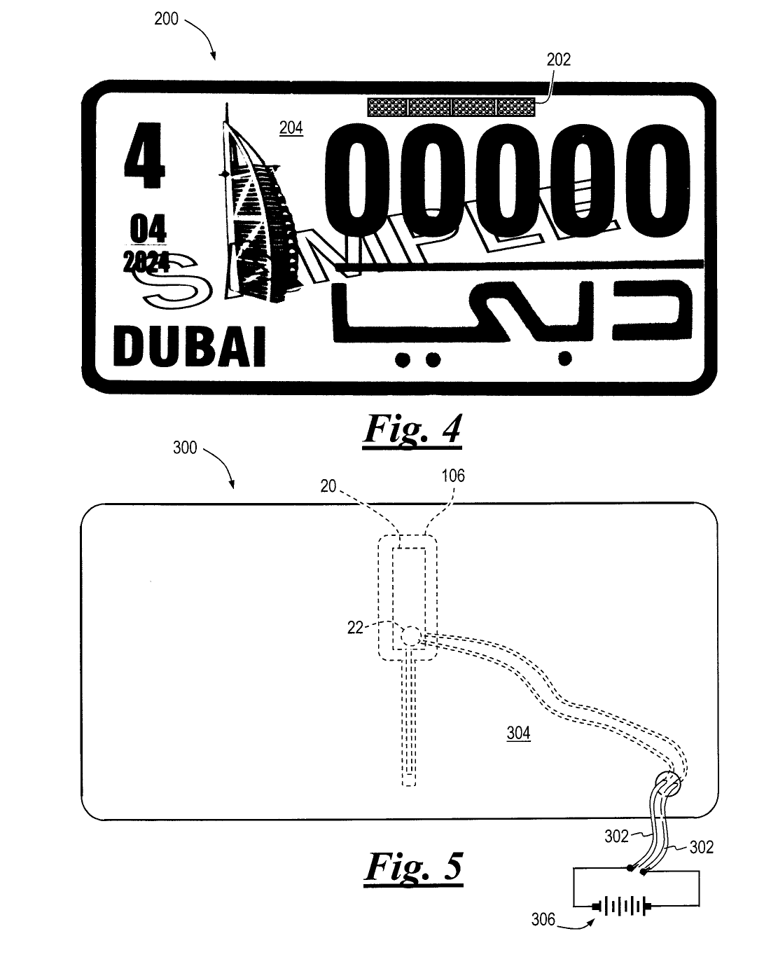

With reference to FIG. 5, in yet another embodiment of the present invention electrical wiring 302 of a license plate 300 may additionally be electrically connected to a vehicle to which the license plate is affixed. Electrical wiring 302 exits a rear surface 304 of license plate 300 and extends between an electrical power supply 306 of the vehicle, such as wiring for a license plate light, and a power supply 22 of an RFID tag 20 to operate the RFID tag and/or charge a battery of the power supply RFID tag. In still other embodiments a license plate may additionally incorporate the features of both license plate 200 and license plate 300.

In operation, any of license plates 10, 100, 200 and 300 are affixed to a vehicle such that the identifying information of the license plate is conspicuously visible. License plates 10, 100, 200 and 300 are configured such that an RFID tag disposed within the license plate is responsive to radio frequency signals from a remote source, as the license plate does not significantly attenuate the radio frequency signals from conventional RFID scanners, thus facilitating electronic registration and tracking of the vehicle to which the license plate is affixed.

While this invention has been shown and described with respect to several detailed embodiments thereof, it will be understood by those skilled in the art that changes in form and detail thereof may be made without departing from the scope of the claims of the invention.

What is claimed is:

1. A license plate for a vehicle, comprising:
a generally planar base having a front surface and a rear surface;
a cavity disposed in at least one of the front surface and the rear surface;
an RFID tag situated in the cavity; and
a closure coupled to the license plate to close off the cavity.

2. The license plate of claim 1 wherein the closure is a cover joined to the rear surface.

3. The license plate of claim 2 wherein the cover is joined to the base with at least one of adhesive, ultrasonic welding, molding and fasteners.

4. The license plate of claim 1 wherein the closure is a sealing material disposed in the cavity.

5. The license plate of claim 4 wherein the sealing material is at least one of adhesive, hot-melt and epoxy.

6. The license plate of claim 1 wherein the base is made from at least one of plastic, metal and composite material.

7. The license plate of claim 1 wherein the RFID tag is a passive type.

8. The license plate of claim 1 wherein the RFID tag is an active type;

9. The license plate of claim 8, further comprising at least one solar cell proximate the front surface and electrically connected to a power supply of the RFID tag to supply electrical power to the RFID tag.

10. The license plate of claim 8, further comprising electrical wiring configured to be connected to an electrical system of a vehicle, the wiring being further connected to a power supply of the RFID tag to supply electrical power to the RFID tag.

11. The license plate of claim 8 wherein the RFID tag further comprises a battery.

12. A license plate for a vehicle, comprising:
a generally planar base having a front surface and a rear surface;
a generally planar cover having a front surface and a rear surface, the rear surface of the cover being joined to the front surface of the base;
a cavity formed in at least one of the front surface of the base and the rear surface of the cover; and
an RFID tag situated in the cavity.

13. The license plate of claim 12 wherein the cover is joined to the base with at least one of adhesive, ultrasonic welding, molding and fasteners.

14. The license plate of claim 12 wherein the cavity comprises facially adjacent cavities formed in the base and the cover.

15. The license plate of claim 12 wherein the base is made from at least one of plastic, metal and composite material.

16. The license plate of claim 12 wherein the RFID tag is a passive type.

17. The license plate of claim 12 wherein the RFID tag is an active type;

18. The license plate of claim 17, further comprising at least one solar cell proximate the front surface and electrically connected to a power supply of the RFID tag to supply electrical power to the RFID tag.

19. The license plate of claim 17, further comprising electrical wiring configured to be connected to an electrical system of a vehicle, the wiring being further connected to a power supply of the RFID tag to supply electrical power to the RFID tag.

20. A license plate for a vehicle, comprising:
a generally planar base having a front surface and a rear surface;
a cavity disposed in at least one of the front surface and the rear surface;
an active-type RFID tag situated in the cavity;
at least one solar cell proximate the front surface and electrically connected to a power supply of the RFID tag to supply electrical power to the RFID tag;
electrical wiring configured to be connected to an electrical system of a vehicle, the wiring being further connected to a power supply of the RFID tag to supply electrical power to the RFID tag; and
a closure coupled to the license plate to close off the cavity.
